(19) United States
(12) Patent Application Publication
(10) Pub. No.: US 2004/0166928 A1
(43) Pub. Date: Aug. 26, 2004

(54) Photographing system for displaying result of game and method of providing service using the system

(76) Inventor: Takasi Kumagai, Setagaya-ku (JP)

Correspondence Address: JORDAN AND HAMBURG LLP, 122 EAST 42ND STREET, SUITE 4000, NEW YORK, NY, 10168, US

(21) Appl. No.: 10/783,855

(22) Filed: Feb. 20, 2004

(30) Foreign Application Priority Data
Feb. 25, 2003 (JP) 047056/2003

(51) Int. Cl. A63F 13/00

(52) U.S. Cl. 463/20

(57) ABSTRACT

A photographing system for displaying a result of a game is arranged to take a photograph of at least a player of a game machine and the player playing a game with the game machine in one frame together with the result of the game. A result of the game desired by the player is displayed on a display apparatus as well as a photograph is taken together with the display apparatus on which the result of the game is displayed or by directly transmitting the result of the game output from the display apparatus to a recording section of a photographing apparatus. The result of the game is photographed in the same frame in which the player is contained.

### BACKGROUND OF THE INVENTION

1. Field of the Invention

The present invention relates to a photographing system and a method of providing a service using the system. More particularly, the present invention relates to a photographing system for photographing a player, when the player gets a high score in a game machine such as a slot machine and the like, together with the score data and to a method of providing the system.

2. Description of the Related Art

It is a great pleasure for a player, irrespective of age or sex, to get a high score with a game machine installed in a game arcade, a casino, and the like where game machines or gamble machines such as slot machines and the like are installed, and it is a natural emotion that the player desires to get a photograph of his or her happy appearance together with the good result.

There are a lot of authorized casinos in the world in which many gamble machines are installed and players play gambles for money with the gamble machines. In Japan, casinos for money are prohibited by the law at present. However, it is not legally a problem to install gamble machines such as slot machines, bingo machines, and the like so that players can enjoy games with them, and it is well known that these machines are installed in event halls and many players enjoy games with the machines.

It is confirmed that many of motivations of a player, who desires photographing, is to get a photograph containing the state of a high score (winning pattern) gotten in the game machine with which he or she played a game and the player himself or herself in order to record and store the good result.

For the player to realize the above request, it is most preferable for the player to be photographed in front of the game machine with which the played a game. In this case, however, a person other than the player must take a photograph of the player. In this photographing, however, the high score displayed on the game machine may not be distinctly photographed, or there are many cases that the high score gotten by the player cannot be photographed because the high score is not displayed on the game machine in the arrangement of the game machine although coins are discharged from the machine as a result of the high score, and the like.

In event halls in Japan, although photographers with a photographing apparatus may circulate in the halls to cope with a request for photographing from players, it is not always easy for a player to call a photographer in the large hall at timing he or she gets a high score. Further, when gambles are authorized actually as in, for example, Las Vegas, USA, many casinos prohibit players to arbitrarily take a photograph arbitrarily because various troubles may be caused thereby. Accordingly, the operators of the casinos must prepare some kind of a service system as to photographing in order to cope with the request of players.

As a means for solving the above point, it is confirmed to built a photographing apparatus in a game machine and to take a photograph of a player who got a high score or to digitally output the high score in the game machine and to print it in a photograph when the player is photographed. In this method, however, first, there arises a problem of getting permission for taking a photograph of the player himself or herself, and, in addition to this problem, a cynical result arises in that the game machine, from which the player got the high score, cannot be photographed and a resultant photograph lacks a recording value because the photographing apparatus is built in the game machine. Further, it is a matter of course that all of the players do not desire photographing regardless of whether they win or lose games, and thus it is very uneconomical to build a photographing apparatus in all the game machines in a hall.

### SUMMARY OF THE INVENTION

An object of the present invention, which was made in view of the above problems, is to provide a photographing system including a game machine and a display means and to provide a service using the system. In the above system, the display means automatically or semi-automatically sets and displays readable high score data, which is output directly from the game machine or output from an external memory medium or from a control center and the like that manages respective game machines so that a photographer takes a photograph of a player, a game machine with which the player got a high score, and the high score data displayed on the display means in one frame.

The present invention includes a photographing system, which has a display means for displaying the contents of a game, a means for requesting photographing to a photographer, and means for photographing a player together with the display means, and a method of providing a service using the photographing system.

The photographing system is arranged such that when a player gets a high score in a game machine (in the following description including embodiments, the present invention is explained as to a slot machine as an example unless otherwise specified), the player issues a photographing request signal to a photographer by lighting a photographing request lamp disposed to the game machine. Note that it is preferable to provide issuing means such as the photographing request lamp and the like with all of game machines. However, since modifying all of the game machines to provide the machines with the issuing means does not always pay in cost, a system, in which the intension of a player can be issued making use of issuing means, is shown in one of the embodiments described below.

There are completed to display, for example, a player, a result of a game obtained in a game machine (the amount of dropped money, the multiplication of a score, the amount of obtained money, and the like), the name of a game hall, a date, the name of the player, and the like as the contents to be photographed after the arrival of the photographer. Note that, as a matter of course, there are a wide variety of display systems for displaying the result of the game depending on the models of game machines.

To store and output the data of a state of a game in the game machine, there can be employed a large variety of arrangements from an arrangement, in which the data of a previous game is stored and displayed on the game machine, to an arrangement in which the data of the contents of a game is neither stored nor output to a magnetic card and the external memory medium of a control center and the like.

Among the above arrangements, in the arrangement in which the data of the contents of the game is recorded in the game machine or the external memory medium, the game machine or the external memory medium is connected to a display apparatus, and the data of a high score is output to the display apparatus. The display apparatus displays, for example, the date of a game, the data of an obtained score, the model of a game machine, the name of a game hall, and the like.

As the method of providing the service, for example, the photographer takes a photograph in such a manner that a player, a display apparatus displaying the above data and the game machine with which the player got the high score are included in one frame. Further, it is also possible to build the display apparatus in a camera and to print the above data in a frame in which the game machine and the player are photographed. Further, in a game machine that has none of the above arrangements, the game machine and the player are photographed such that the display portion of the game machine is clearly photographed, or the above data is manually set to the display apparatus and the player is photographed together with the display apparatus. Note that when the data is manually set, it is set by a clerk in charge of photographing who is authorized by a game hall to prevent that false data is set.

Since the display apparatus is photographed together with the player unless it is built in the camera as well as is carried to a location where each player exists, it is not preferable to arrange the display apparatus in a too large size, and thus the display apparatus preferably is set to a size that can be held by the player. However, since the display apparatus is an important image element in a photograph taken by the photographer, it is confirmed to design it in, for example, an oval shape, a heart shape, and the like and to arrange it as a hanging type display apparatus that is hung from the neck of a player, a placard type display apparatus to which a grip is formed, and the like in place of a hand-held type display apparatus.

### BRIEF DESCRIPTION OF THE DRAWINGS

FIG. 1(A) is a front elevational view of a slot machine capable of using a system according to the present invention, FIG. 1(B1) is a view showing the arrangement of a button for requesting photographing, and FIG. 1(B2) is a view showing another arrangement of the button;

FIGS. (2A) and (2B) are perspective views of a display apparatus;

FIG. 3 is a perspective view of a manual setting/operating unit;

FIG. 4 is a view showing a data transmission state between slot machines and a control center;

FIG. 5(A) to FIG. 5(C) are views showing examples of connection between a display apparatus and a data input terminal;

FIG. 6 is a perspective view of a photoelectric conversion connector;

FIG. 7 is a perspective view of a cart on which a photographing system is loaded;

FIG. 8 is a view showing an example of the arrangement of a photograph taken by the system of the present invention;

FIG. 9 is a flowchart showing an example of a procedure from a request for photographing from a player to photographing;

FIG. 10 is a side elevational view partly in cross section of a Polaroid type instant camera in which a small display apparatus is built in; and

FIG. 11 is a side elevational view partly in cross section of a digital camera which has a CCD and in which a small display apparatus is built in.

### DESCRIPTION OF THE PREFERRED EMBODIMENTS

An embodiment of the present invention will be described below with reference to the drawings.

Even if a game machine, which is a subject in which the present invention is embodied, is limited to a slot machine, the storage, the display, and the like of game data can be classified to many arrangements. Since the present invention must be embodied individually in correspondence to the respective arrangements of the game machine, first, the classification of the arrangement of the game machine will be shown below. Note that although many of game machines such as slot machines and the like can record the personal registration data of a player in a magnetic recording card as an external recording medium owned by the player by inserting the card, game machines and the like, which are not arranged as described, still exist.

(A) A case that the contents of an immediately preceding game and a result obtained from the game are recorded in a game machine itself and the game machine has means for outputting the recorded data to the outside;

(A-1) A case that a magnetic card and the like are used as means for recording the output data, and the contents of an immediately preceding game and a result obtained from the game are recorded in the card by inserting it;

(A-2) A case that an external unit, which is connected to the game machine through a cable with a connector or using a radio transmission mechanism employing infrared rays, electromagnetic waves, and the like, is used as means for recording the output data, and the contents of an immediately preceding game and a result obtained from the game are recorded in the external unit;

(B) A case that although the contents of an immediately preceding game are recorded in a game machine itself, the game machine is not provided with means for outputting the contents;

(B-1) A case that the game machine is connected to a control center and the like that manages a plurality of game machines, and the contents of an immediately preceding game and a result obtained from the game are transmitted to the control center and the like at all times;

(B-2) A case that although the contents of an immediately preceding game and a result obtained from the game are displayed on a game machine itself every time they occur, the game machine is provided with neither means for outputting the data to an external recording medium such as an output card and the like nor means for transmitting the data to the control center;

(C) A case that the contents of an immediately preceding game are not recorded in a game machine itself;

(C-1) A case that the contents of an immediately preceding game and a result obtained from the game are sent to a control center every time they occur; and

(C-2) A case that the contents of an immediately preceding game and a result obtained from the game are not recorded in a game machine as well as the data is not transmitted.

An example of the arrangement of the present invention will be described below as well as a state, in which the present invention is embodied in correspondence to the arrangements of the game machine, will be specifically explained.

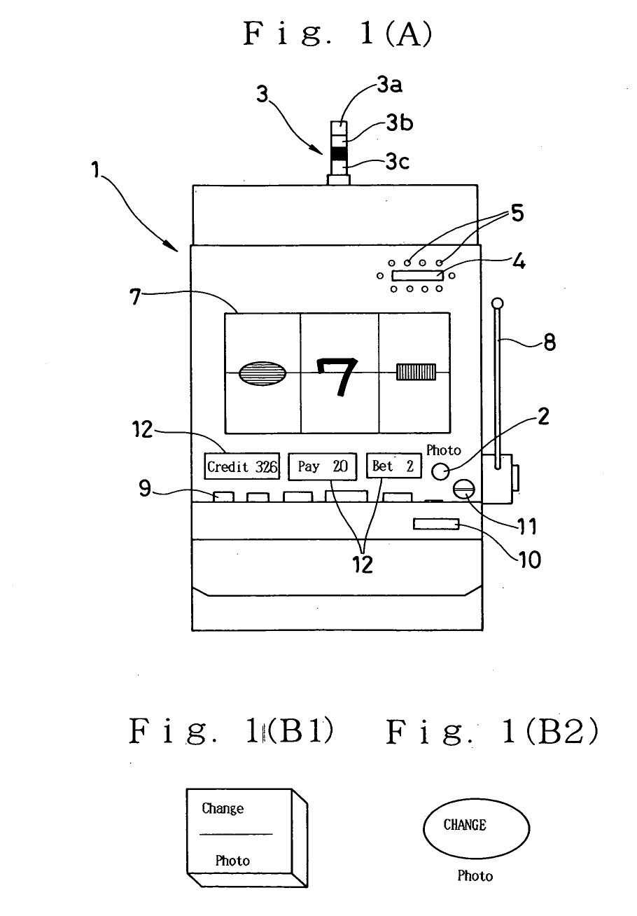

FIG. 1 shows a slot machine acting as one of the game machines to which the present invention is embodied.

Although the slot machine shown by an arrow 1 in FIG. 1 is arranged basically similarly to a known slot machine, some functions are added to the machine so that it corresponds to the present invention. First, the added functions will be explained. Reference numeral 2 denotes a photographing request button, 3a denotes a photographing request lamp of display lamps 3 that is lit by depressing the photographing request button 2. Further, reference numeral 3b denotes an error lamp, and 3c denotes a change request lamp.

Next, other portions of the slot machine 1 will be explained. Reference numeral 4 denotes a card insertion slot, 5 denotes card communication check lamps 5, 7 denotes a winning pattern display window, 8 denotes a spin operation lever, and 9 denotes an change request button 9, and the change request lamp 3c of the display lamps 3 is lit by depressing the change request button 9. Reference numeral 10 denotes a banknote insertion port, 11 denotes a coin drop port, and 12 denotes display units for displaying the contents of a game.

FIGS. 2(A) and 2(B) show a display apparatus for displaying the contents of a play in the slot machine 1 as the game machine shown in FIG. 1. When a player gets a high score, the display apparatus, which displays the contents of the high score, is photographed together with the player by being, for example, held by a hand of the player.

First, reference numeral 3 in FIG. 2(A) denotes the display apparatus as its main body. When the player gets the high score, the display apparatus 13 displays the contents of the high score on a display unit that will be described later as well as the display apparatus displaying the high score, the player, and the slot machine as the game machine are photographed in one frame. Thus, the display apparatus is arranged to have a size which can be held by the player. Note that although the display apparatus 13 shown in the figure is formed in an approximately rectangular box-shape, it is not limited to the box-shape and any arrangement and shape may be employed as long as they can be photographed in one frame together with the player. There are confirmed various arrangements and shapes for the display apparatus 13 such as an arrangement for permitting the display apparatus 13 to be hung from the neck of a player, a placard type display apparatus to which a grip is formed, and the like.

Reference numeral 14a denotes a date display unit for displaying a date when a game is played, 14b denotes a content of game display unit, 14c denotes a result of game display unit, and 14d denotes a model display unit for displaying a model of a game machine. Reference numeral 15 denotes a hall name display unit for displaying the name of a hall where a game machine is installed. Reference numeral 16 denotes a card insertion slot into which a card is inserted. Further, reference numerals 17a to 17d denote manual setting buttons for manually setting data to be disposed on the respective display units in the model of machines in which data cannot be obtained from a card.

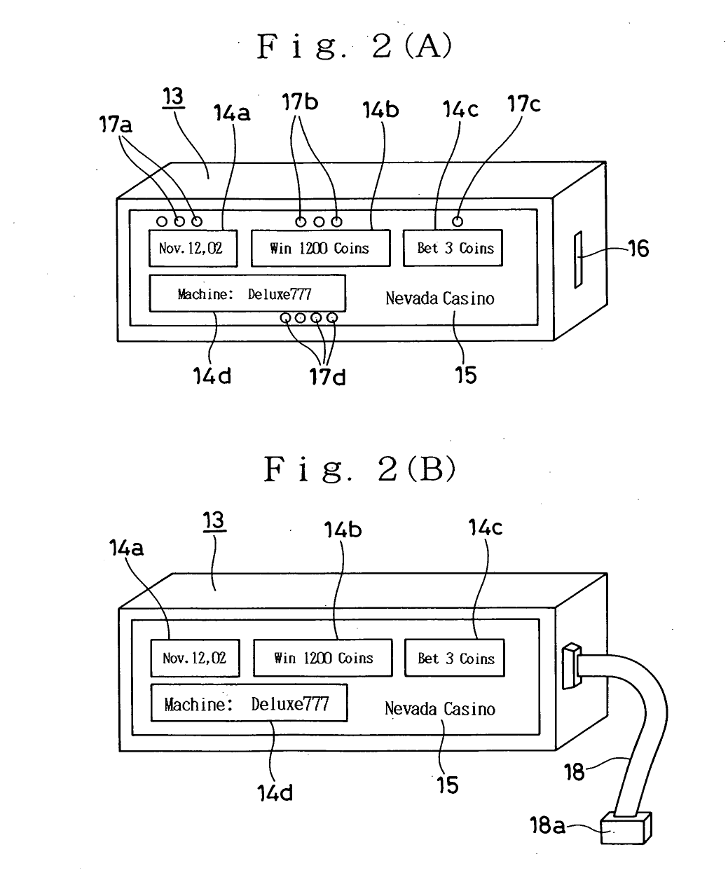

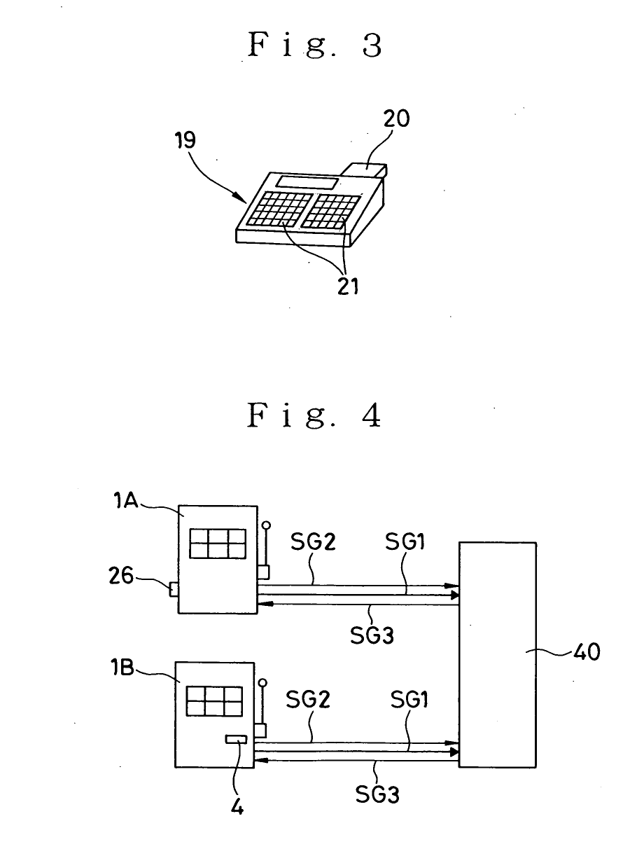

The display apparatus 13 of FIG. 2(B) includes a cable 18 with a connector 18a as means for connecting the display apparatus 13 to a separately arranged manual setting unit 19 shown in FIG. 3. Although the display apparatus 13 ordinarily receives data from the game machine through the cable 18, in the model of a machine which cannot automatically transmit the data, the data is manually set to the display apparatus 13 through the manual setting unit 19. The other arrangements of the display apparatus 13 shown in FIG. 2(B) are basically common to the arrangements of the display apparatus 13 shown in FIG. 2(A). It is needless to say that the manual setting buttons 17a to 17d included in the display apparatus shown in FIG. 2(A) are not provided with the display apparatus 13 of FIG. 2(B) because the data is manually set by the external manual setting unit 19.

The manual setting unit 19 in FIG. 3 is connected to the display apparatus 13 of FIG. 2(B) through the cable 18 with the connector 18a, and reference numeral 20 denotes a connector to be connected to the connector 18a of the cable 18, and 21 denotes data input keys.

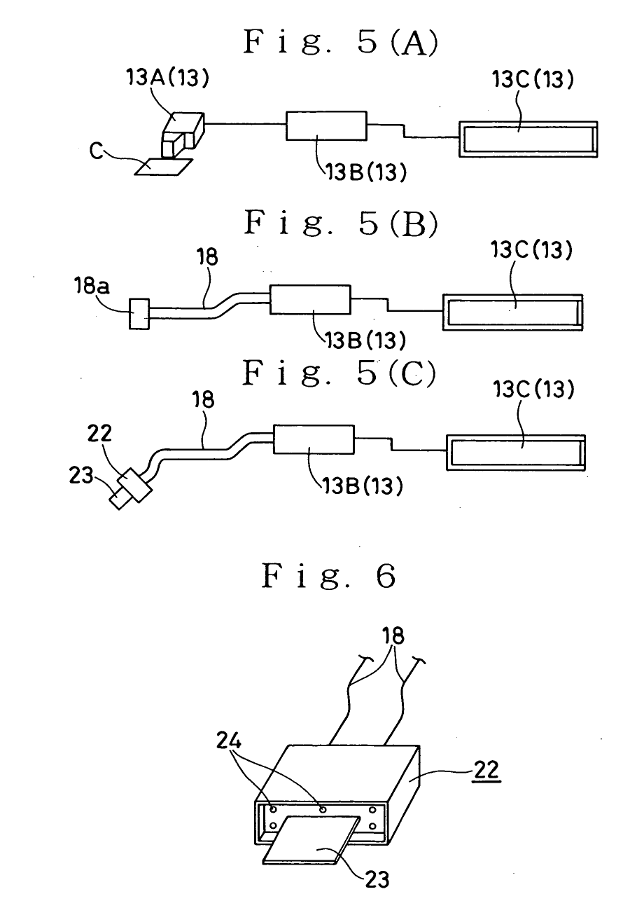

FIGS. 5A to 5C show the specific arrangements of a method of capturing data to the display apparatus 13, and the specific arrangements of the data capturing method will be explained in correspondence to the data storing method of the slot machine 1 acting as the game machine and to the arrangement of the display apparatus.

(a) A case that the slot machine described above uses the card such as the magnetic card and the like as the means for recording output data, and the contents of the immediately preceding game and the result obtained from the game are recorded in the magnetic card by inserting the card (A-1);

In the case of this arrangement, the display apparatus 13 shown in FIG. 2(A) is used. A player or a photographer extracts a card C inserted into the card insertion slot 4 of the slot machine 1, inserts the card C into a card insertion slot 16 of the display apparatus 13, downloads the data of the contents of the immediately preceding game executed by the player in the slot machine 1 and displays the data at a predetermined display portion of the display apparatus 13 based on the data. FIG. 5(A) shows the internal arrangement of the display apparatus 13 used at the time, wherein reference numeral 13A denotes a card reader for reading the data of the inserted card C, 13B denotes a controller, and 13C denotes the display portion of the display apparatus 13. Note that, in this case, when a part of the data to be displayed is not output from the slot machine 1 because the slot machine 1 does not have means for arranging, for example, a date of a game as data, the data is manually set using any of the manual setting buttons 17a to 17d shown in FIG. 2(A). Further, the means for manually setting the data is not limited to the buttons, and the data may be set by a system for manually manipulating a dial window and the like directly.

When predetermined data is displayed on the display apparatus 13, the player stands alongside the slot machine 1 as the game machine with which the player got a high score while holding the display apparatus 13 in a state that the display portion of the display apparatus 13 faces a photographer, and the photographer takes a photograph of the player together with the slot machine 1 and the display apparatus 13 so that they are recorded in one frame.

(b) A case that the means for recording the output data is the external unit connected to the game machine using the cable with the connector, and the contents of the immediately preceding game and the result obtained from the game are recorded in the external unit (A-2);

In the above arrangement, the display apparatus shown in FIG. 2(B) is used. The data of the immediately preceding game is obtained from the slot machine 1 by connecting the terminal 18a of the connector cable 18 to the connector (not shown) of the slot machine 1 and displayed on the display unit 13C through the controller 13B (arrangement of FIG. 5(B)). The photographing method and the like other than the above method of the case (b) is the same as those of the case (a).

Note that when the means for receiving the output data is the external unit employing the radio transmission system that receives the data from the game machine through infrared rays, electromagnetic waves, and the like, it is a matter of course to use a data transmission mechanism (not shown) used in a TV remote controller and the like in place of the cable with the connector.

(c) A case that the game machine is connected to a control center and the like for managing a plurality of game machines, and the contents of an immediately preceding game and a result obtained from the game are sent to the control center and the like (B-1);

In the above case, when the slot machine 1 is provided with means for requesting the control center and the like to feed back the data transmitted thereto from the slot machine 1, the data as to the contents of the immediately preceding game is returned to the slot machine 1 once using the means and downloaded to the display apparatus 13 in correspondence to the above case (a) or (b), and predetermined contents are displayed.

Further, when the feedback means is not provided (C-1), the photographer downloads, for example, the data of the predetermined slot machine 1 to the display apparatus at the control center and passes the display apparatus to the player as well as takes a photograph of the player in front of the game machine from which the high score was gotten.

(d) A case that although the contents of the immediately preceding game and the result obtained from the game are recorded in and displayed on the game machine itself as internal data every time they occur, the game machine is provided with neither means for outputting the data to the external recording medium such as the output card and the like nor means for transmitting the data to the control center (B-2) or a case that that although the contents of the immediately preceding game and the result obtained from the game are displayed on the game machine, they are neither recorded as the internal data nor transmitted (C-2).

In the above cases, in the display apparatus of FIG. 2(B), the connector cable 18 is connected to the connector 20 of the manual setting operation unit 19 shown in FIG. 3, and the photographer manually sets a result of a score and the like displayed on the slot machine 1 using keys 21 and displays it on the display unit 13C of the display apparatus 13. Further, in the display apparatus of FIG. 2(B), the photographer manually sets the result of the score using the manual setting buttons 17a to 17d. In this case, it is preferable that the photographer and the like who are authorized by a game hall executes the manual setting as described above so that false contents are not displayed.

Note that although the arrangement of the display apparatus 13 is shown by being divided into the arrangements shown in FIGS. 2(A) and 2(B), it is possible to arrange the functions shown in FIGS. 2(A) and 2(B) in a single display apparatus.

Next, an output state of a result of a game in the slot machine 1 will be explained in more detail.

First, when the slot machine 1 is provided with the card insertion slot 4 as shown in FIG. 1, the contents of an immediately preceding game can be recorded in an inserted card as data. As a method of recording the data, it is also possible to compare the data of the latest game with the data of the recorded game and to store only the data of a higher score at all time so that the data of the highest core remains in the card in a series of games being played, in addition to an ordinary method of replacing the recorded contents of the games with the contents of the game played each time by sequentially overwriting the contents of the games.

In the above arrangement, the respective game machines can be modified almost by the modification of software, which is advantageous in cost. However, since many of cards owned by ordinary players do not have the above data storing function, it is useful to employ such a system that a photographer carries a dedicated card, and the contents of a game are automatically written to the card when the photographer inserts the card. Further, it is also confirmed to use the card communication check lamps 5 disposed near the card insertion slot 4.

In many cases, since the card communication check lamps 5 are composed of LEDs, the LED lamps are blinked based on a specific protocol to thereby output the result of a game to the display apparatus 13 in response to the blinking of the LED lamps. FIG. 6 shows a photoelectric conversion connector 22 for realizing the above arrangement. Reference numeral 23 denotes a positioning member formed as wide as the card C so that the positioning member 23 can be inserted into the card insertion slot 4 of the slot machine 1 similarly to the card C.

When the positioning member 23 of the photoelectric conversion connector 22 is inserted into the card insertion slot 4 of the slot machine 1, the respective light receiving units 24 of the photoelectric conversion element disposed in the photoelectric conversion connector 22 are positioned near to the respective LED lamps 5 of the slot machine 1, the blinking of the respective LED lamps 5 is converted into an electric signal by the photoelectric conversion element and output as the electric signal, thereby the results of games are sequentially displayed on the display unit 13c of the display apparatus 13 (arrangement of FIG. 5(C)). Since this system can be almost realized only by the modification of software, it can modify existing game machines advantageously in cost.

Note that it is also useful to arrange the card-type positioning member as an information card in which particular information is input and to cause the positioning member to act as a data transmission command means to the slot machine when it is inserted into the slot machine.

When it is difficult to execute the above two methods, a data transmission connector is provided. In this case, it is also confirmed to minimize the modification of hardware making use of the sockets of the LED lamps 5. The socket of at least one of the LED lamps 5 is modified to a socket into which an external connection pin is inserted, and data is transmitted in serial communication using a protocol similar to that described above.

Further, when it is difficult to execute any of the above three methods, a connector is separately provided with the main body of the game machine at a portion thereof. The connector is not limited to a connector for connecting a cable and may be used to transmit data through infrared rays and electromagnetic waves, and further it is possible to mount a data receiving device on the display apparatus 13 to receive the data.

Further, when a result of a game of the slot machine 1 is automatically transmitted to a control center 40 and no data remains in the slot machine 1, the game data output to the control center 40 must be fed back to the slot machine 1.

In FIG. 4, reference numeral 1A denotes a slot machine provided with the above connector (denoted by reference numeral 26), and 1B denotes a slot machine provided with the card insertion slot 4. Any of the slot machines 1A and 1B is connected to the display apparatus 13 at all times as described above so that the result of the game can be displayed on the display apparatus 13 as necessary. In this case, however, means for transmitting a data feedback request signal SG2 is necessary. Although it is of course sufficient to provide a manipulation means such as a signal feedback request button and the like, there is confirmed a method of providing software for automatically transmitting the data feedback request signal SG2 by inserting a card or a connector. This method can be easily realized by that the card records information different from that recorded in the card ordinarily owned by a player.

When slot machines are arranged as described above, the respective slot machine 1A and 1B execute ordinary data transmission SG1 for one-sidedly transmitting the result of the game to the control center 40. In the above arrangement, the game data feedback request signal SG2 is arranged so that it is output as an up-signal as well as the game data is fed back (SG3) as a down-signal in response to the request signal SG2, and the display apparatus 13 connected to the slot machine 1A or 1B displays the fed-back game data.

Next, a mean through which a player calls a photographer, the arrangement of a photographing camera, and the like will be explained.

When the player plays a game with the slot machine 1 shown in FIG. 1 and desires to get a photograph because he or she got a high score, the player depresses the photographing request button 2. In an ordinary photograph request method, the photographing request lamp 3a of the display lamps 3 is lit in response to the depression of the button, and the photographer goes to the game machine at which the lamp is lit and takes a photograph. In this method, however, the game machine must be modified. Since the modification of the game machine is disadvantageous in cost, it is confirmed to make use of a change request signal to minimize the modification of the game machine.

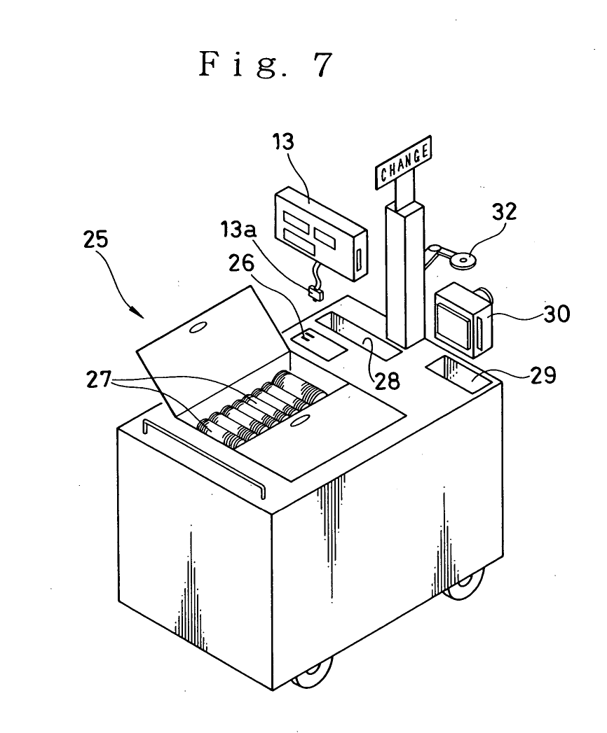

In casinos and the like where cash is dealt with, a clerk in charge of change circulates in a hall while pushing a cart carrying a lot of coins so that a player can change cash with coins without departing from a game machine while he or she plays a game. FIG. 7 shows a cart modified to embody the present invention. When the clerk in charge of change recognizes that a change request lamp provided with each game machine is lit, he or she goes to the game machine on which the lamp is lit at once and responds to the requirement for change of the player. Thus, in the photographing system of the present invention, it is confirmed that the clerk in charge of change also acts as a photographer and the game machine lights only the change request lamp even if a player depresses the photographing request button.

When both a request for change and a request for photographing are coped with by the same person, the change request lamp acts as the photographing request lamp as it is. In this case, a modification cost can be minimized because it is only necessary to modify the term “Change” displayed on a button of a game machine to a term “Change/Photo”, and it is sufficient that the clerk in charge of change called by a player orally receive a request for change or a request for photographing from the player. FIG. 1(B1) shows an arrangement that terms “Change” and “Photo” are attached to one button, and FIG. 1(B2) shows an arrangement that a term “Photo” is displayed near a change button.

Further, it is also confirmed to recommend a player to get a photograph when a result of a high score and the like occurs.

In general, in slot machines and the like, a display such as “Insert Coin” is made in a display window 12 shown in FIG. 1 to prompt a player to play a game. Thus, when the player gets a result of a high score, it is possible to make a display for recommending photographing to the player such as “Congratulation!, when you desire to get a photograph, depress “CHANGE” button”. Since this arrangement can be realized only by modifying software, it is advantageous in cost.

Further, since an ordinary person in charge of change changes money without a fee, when a pay photographing system is employed, that is, when a photograph is sold, an amusement place can get an additional income. Note that various methods can be employed to collect a photograph fee such as a method of deducing the fee from changed money, a method of directly collecting the fee in exchange with a photograph, and the like. In addition, since the player is proud of his or her photograph, there is a high probability that player shows the photograph to his or her family and friends, from which the advertising effect of the amusement place, in which the photograph was taken, can be expected.

In FIG. 7, reference numeral 25 denotes a cart which is loaded with a lot of coils 27 for change as usual. In the present invention, however, the cart must be loaded at the same time with a photographing apparatus for the photographer who also acts as the clerk in charge of change. That is, the display apparatus 13 and a camera (for example, an instant camera) 30 are held in holding sections 28 and 29 when they are not used.

It is of course possible to use an external power supply as the power supply of the display apparatus 13. However, incorporating a battery in the display apparatus 13 is very convenient because it is possible to take a photograph without a cord in photographing. Note that the illustrated cart 25 is provided with a power supply unit 26 which can be connected a power supply plug of the display apparatus 13 so that the power from the power supply unit 26 can be used as external power for operating the display apparatus 13 as well as the power can be also used to charge a battery incorporated in the display apparatus 13.

An example of the case that the display apparatus 13 incorporates the battery will be explained below.

When the clerk in charge reaches a game machine where a player desires to get a photograph, the score data in the game machine is output to and displayed on the display apparatus 13 by any of the connection systems shown in, for example, FIGS. 5(A) to 5(C) in correspondence to the data processing executed in the game machine. Although it is assumed that this core is a high score in many cases, it not always necessary that the score is the high score as long as the player desires to get a photograph.

When predetermined data is displayed on the display apparatus 13, it is passed to the player. In contrast, the clerk in charge takes out the camera 30 from the cart 25 and takes a photograph of the player, the game machine, and the display apparatus 13 so that they are contained in one frame in a state that the display portion of the display apparatus 13 held by the player is aimed at the camera 30. When the camera 30 is an instant camera, a photograph is passed to the player at once. Further, when the camera 30 is a digital camera using a CCD, a hard copy of the photograph is printed by a printer and passed to the player after a result of photographing is displayed on, for example, a liquid crystal display surface of the digital camera or on a separately prepared display surface and an acceptance of the player for the photograph is obtained. Note that it is also possible for the clerk in charge to take the photograph by securing the camera 30 on a camera mounting table 32 attached to the cart 25, in addition to that he or she takes the photograph while holding the camera 30 with hands.

Note that forming the display apparatus 13 in the box-shape as shown in FIG. 2 is not an indispensable constituent feature of the present invention as described above.

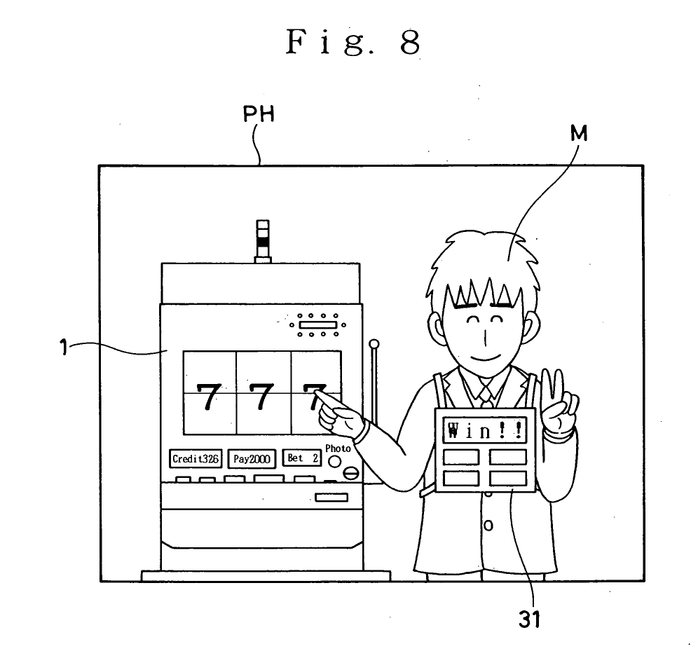

FIG. 8 shows a case that photographing is executed by forming the display apparatus in a shoulder type. Reference symbol PH shows the frame of a photograph having been taken. Reference numeral 31 denotes the shoulder-type display apparatus. A clerk in charge of photographing fits the display apparatus 31 to a player M after he or she displays predetermined data on the display portion of the display apparatus 31 by the method described above, and the player M is photographed while making a V-sign with one hand and indicating the slot machine 1 with which he or she got a high score with other hand as shown in the figure. A degree of freedom of the player as a subject for taking a pose of expressing his or her pleasure can be increased in photographing by arranging the display apparatus as the shoulder type display apparatus because both the hands of the player M can be made more free, thereby it is possible to take a more impressive photograph.

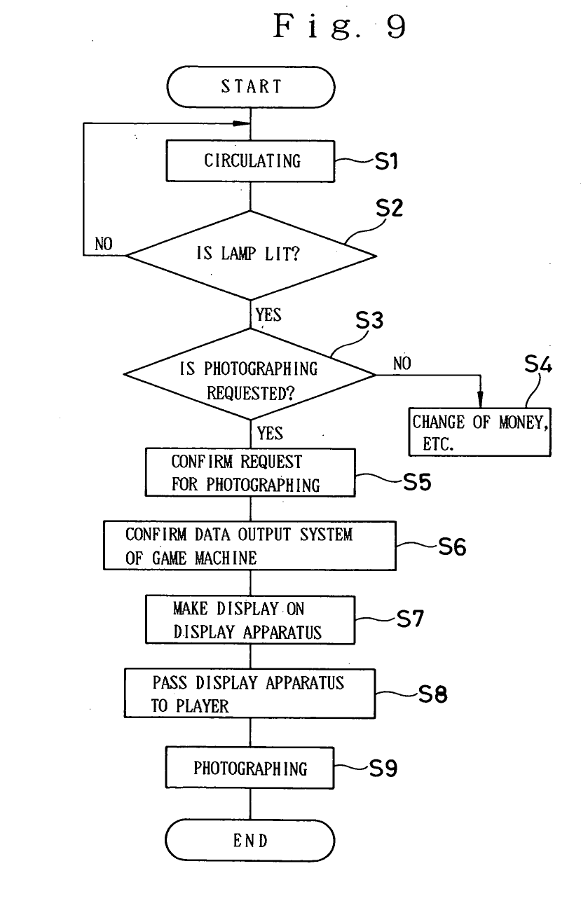

FIG. 9 mainly shows an example of a procedure of the clerk in charge until a photograph is taken.

The clerk in charge always circulates a casino while pushing the cart shown in FIG. 7 and checks whether or not the lamps of the respective game machines are lit (S1, S2).

When the clerk in charge finds a game machine whose lamp is lit, he or she goes to the game machine at once, confirms whether or not a player desires photographing according to a direct request from the player or the lit state of the lamp, and when the request of the player is other than photographing, the person executes a predetermined service, for example, changes the coils 27 (S4).

When it is confirmed that the player desires photographing (S5), the clerk in charge confirms the processing system of game data in a game machine with which the player plays a game from the type and the like of the game machine (S6), captures the game data from the game machine to the display apparatus in correspondence to the processing system and displays the predetermined data on the display portion of the display apparatus (S7). Note that when there are a lot of game machines having a different data processing system in the casino, a device, which shows a method of obtaining game data in correspondence to, for example, a model, is loaded on the cart 25 so that a game data obtaining method corresponding to a particular model is shown, thereby the workload of the clerk in charge can be greatly reduced. When the game data is displayed on the display apparatus, the clerk in charge passes the display apparatus to the player (S8) and takes a photograph by the procedure described above (S9).

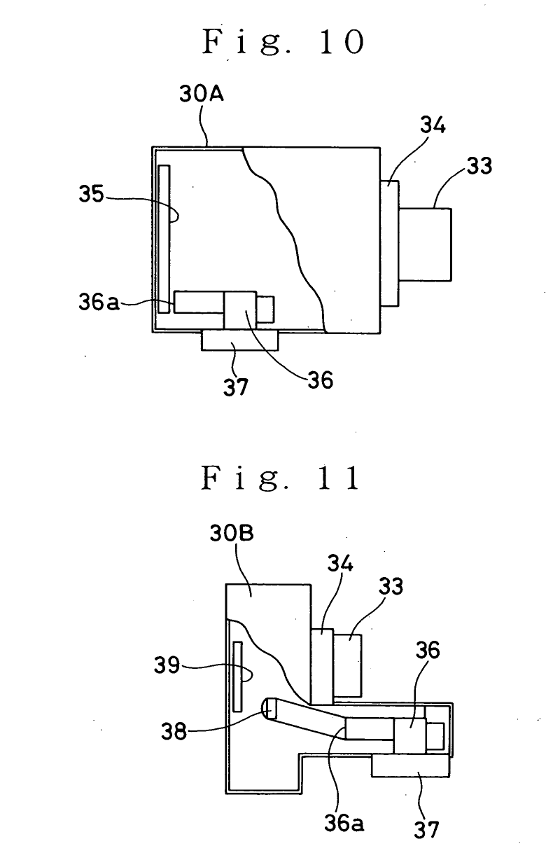

Next, FIGS. 10 and 11 show an arrangement in which the display apparatus is built in a camera.

Reference numeral 30A in FIG. 10 shows a Polaroid type instant camera, wherein 33 denotes a lens, 34 denotes a shutter mechanism, and 35 denotes a film accommodated in a camera main body. Reference numeral 37 denotes a data input unit for inputting game data, and the data input section is arranged as a card inserting unit or a data collection connector.

In the above arrangement, when game data is captured into a display apparatus 36 built in the camera type, the player and the game machine are photographed in the state that they are included in one frame. As soon as the lens 34 is actuated, the game data in the display apparatus 36 is displayed on a light emitting type data display surface 36a, and the displayed contents are printed onto the film 35, thereby a photograph in which a result of a game is printed in the frame, in which the player and the game machine are photographed, is finished.

A camera denoted by numeral reference 30B in FIG. 11 is a digital type camera for capturing an image to a CCD. The camera 30B captures game data and the like in the same method as that of the camera 30A. However, since a CCD image surface 39 of the CCD is smaller than the film 35 of the instant camera 30A, photographing is executed by reducing the display on the light-emitting type display surface using a reduction lens 38 so that the display corresponds the size of the CCD image surface 39. In this case, it is needless to say that the game data may be directly recorded to pixels or an image recording medium as a digital signal in place of photographing it in the camera as a light-emitting type image.

A person skilled in the art can easily conceive that the present invention can be used in various types of game machines other than the slot machine.

When a player desires to store a result of a game in a photograph as in the case that the player got a high score in a game machine, the player can get a photograph having a high recording property because the player and the game machine can be photographed in one frame in the state that the result of the game is distinctly displayed therein.

Further, it is possible to take a photograph that displays a result of a game in the game machines including the game machines that cannot record a result of a game at all regardless of data processing executed in the game machines as well as the present invention can be used in almost all the types of existing game machines without modifying them. Accordingly, the present invention can be used in a very wide field.

Further, a photograph desired by a player can be taken as well as both an improvement in profitability by photographing and advertisement of a game hall can be achieved without the need of modifying the respective game machines or at a minimum modification cost on the premise that a clerk in charge of change, and the like, who circulate in a game hall where personal photographing is prohibited, also act as a photographer.

What is claimed is:

1. A photographing system for displaying a result of a game arranged to take a photograph of at least a player of a game machine and the player playing a game with the game machine in one frame together with the result of the game, wherein a result of the game desired by the player is displayed on a display apparatus as well as a photograph is taken together with the display apparatus on which the result of the game is displayed or by directly transmitting the result of the game output from the display apparatus to a recording section of a photographing apparatus, and the result of the game is photographed in the same frame in which the player is contained.

2. A photographing system for displaying a result of a game according to claim 1, wherein the game machine has a function for outputting the contents of a game to an external recording medium such as a magnetic card and the like, the display apparatus has a function for inputting the contents of the game recorded in the external recording medium, and the display apparatus displays a result of a predetermined game of the game machine through the external recording medium.

3. A photographing system for displaying a result of a game according to claim 1 or 2, wherein the game machine comprises a data output connector for outputting the result of the game to the outside, and the display apparatus comprises a data collection connector that is connected to the connector of the game machine and inputs the result of the game output from the game machine.

4. A photographing system for displaying a result of a game according to claim 1 or 2, wherein the game machine has a function for outputting the result of the game to the outside by a radio system data transmission using visible light rays, infrared rays, electromagnetic waves, and the like, and the display apparatus has a transmitted data collecting/receiving function for inputting the result of the game output from the game machine.

5. A photographing system for displaying a result of a game according to any of claims 1 to 4, wherein the game machine comprises light-emitting means disposed near an external recording medium insertion slot for displaying a connecting state of the game machine to the external recording medium such as a magnetic card and the like, the display apparatus comprises a photoelectric conversion light-receiving connector for collecting data, the photoelectric conversion light-receiving connector comprises a positioning member acting as positioning means that is inserted into and engaged with the external recording medium insertion slot, a light emitter of the game machine is disposed in confrontation with a photoelectric conversion light receiving section of the photoelectric conversion light-receiving connector by the positioning member, and the data of the result of the game of the game machine is output to the display apparatus by emitting the light-emitting means of the game machine by a predetermined protocol.

6. A photographing system for displaying a result of a game according to any of claims 1 to 5, wherein the display apparatus comprises a manual setting mechanism, and at least a part of the result of the game displayed by the game machine is manually input to the display apparatus or the contents of the result of the game displayed by the game machine are manipulated by the manual setting mechanism, respectively.

7. A photographing system for displaying a result of a game according to any of claims 1 to 6, wherein the display apparatus and the photographing apparatus are mounted on a cart that is circulated by a clerk in charge in a hall in which game machines are installed.

8. A photographing system for displaying a result of a game according to claim 7, wherein the game machine comprises means for calling a clerk in charge of photographing.

9. A photographing system for displaying a result of a game according to any of claims 1 to 8, wherein the game machine displays that change request input means such as a change request button and the like also acts as means for requesting photographing.

10. A photographing system for displaying a result of a game according to 1, wherein the game machine outputs a result of an immediately preceding game to an external recording medium by an operation for outputting the data to an external device such as insertion of the external recording medium, and the like into the game machine.

11. A photographing system for displaying a result of a game according to any of claims 1 to 6, wherein the game machine compares a game with an immediately preceding game, records a result of a game having high evaluation under a specific evaluating condition such as a high score, a high magnification, and the like and outputs a result of a game that has obtained a maximum evaluation in a series of games to the outside.

12. A photographing system for displaying a result of a game according to claim 1, wherein the game machine automatically outputs the result of the game to an intensive control unit of a game hall as well as comprises means for requesting to feed back the result of the game automatically output to the intensive control unit to the game machine, and the data of the result of the game fed back through the game machine is output to the display apparatus.

13. A photographing system for displaying a result of a game according to any of claims 1 to 10, wherein the display apparatus is of a hand-held type, and the player as a subject gets a photograph while holding the display apparatus showing the result of the game.

14. A photographing system for displaying a result of a game according to any of claims 1 to 10, wherein the display apparatus is of a shoulder type and the like so that it can be directly fitted to the player as the subject.

15. A photographing system for displaying a result of a game according to any of claims 1 to 6, wherein the display apparatus is built in the photographing apparatus, and the result of the game input to the display apparatus is displayed and recorded on an image recording surface in photographing.

16. A photographing system for displaying a result of a game according to 15, wherein the photographing apparatus comprises a Polaroid type instant camera, and a display on the light-emitting type data display surface of the display apparatus is printed to a film of the camera.

17. A photographing system for displaying a result of a game according to 15, wherein the photographing apparatus comprises a digital camera having a CCD, and a display on the light-emitting type data display surface of the display apparatus is output to the CCD through a reduction lens.

18. A method of providing a service using a photographing system for displaying a result of a game arranged to take a photograph of at least a player of a game machine and the player playing a game with the game machine in one frame together with the result of the game, wherein a photographer is limited to a clerk in charge of photographing who is admitted to execute photographing in a game hall, at least one of a winning pattern, the amount of a prize, the amount of dropped money, a winning multiplication of the contents of a game is displayed on the game machine or an display apparatus, and the player gets a photograph in which the player and the game machine or the display apparatus, which displays the contents of the game, are photographed in one frame.

19. A method of providing a service using a photographing system for displaying a result of a game according to claim 18, wherein the clerk in charge of photographing is a clerk in charge of change whose job is to circulate in a game hall at all times and to change money, a player calls the clerk in charge of change through change request means disposed to a game machine and directly requests the clerk in charge of change to take a photograph or to change money.

20. A method of providing a service using a photographing system for displaying a result of a game according to claim 18 or 19, wherein the game machine is provided only with change request means such as a change request lamp and the like, the player calls the clerk in charge of change using the change request means and orally requests the person to take a photograph or to change money, and it is displayed to the change request input means such as the change request button and the like that the means also acts as means for requesting photographing.

21. A method of providing a service using a photographing system for displaying a result of a game according to claim 18 or 19, wherein the game machine comprises photographing request means, and the clerk in charge of change can confirm the request of a player before the person reaches the player who called him or her.

22. A method of providing a service using a photographing system for displaying a result of a game according to any of claims 18, 19 and 21, wherein the game machine is arranged such that when a high evaluation is obtained under specific conditions of a high multiplication, a high score, and the like in which a predetermined multiplication, for example, is achieved with respect to an amount of dropped money as a result of a game, change request display means, photographing request display means, or photographing recommendation display means is automatically operated, and the clerk in charge of photographing is called by the display means.

23. A method of providing a service using a photographing system for displaying a result of a game according to claim 19, wherein a photographing apparatus is loaded on a cart that is used by the clerk in charge of change to transport money for change when the clerk circulates, and the clerk in charge of change called by a player can change money or take a photograph at once in correspondence to the request of the player.

24. A method of providing a service using a photographing system for displaying a result of a game according to any of claims 18 to 23, wherein a photographing fee is previously set to photographing, and when the photographing is executed, the photographing fee is directly asked to a player or drawn from money on deposit.
